(19) United States
(12) Patent Application Publication
(10) Pub. No.: US 2015/0314406 A1
(43) Pub. Date: Nov. 5, 2015

(54) HEAT EXCHANGE SYTEM AND METHOD OF PRODUCING THE SAME

(71) Applicant: KONINKLIJKE PHILIPS N.V., EINDHOVEN (NL)

(72) Inventors: BRIAN EDWARD DICKERSON, CANTON, GA (US); JOHN TRUITT SOSEBEE, JR., CANTON, PA (US)

(21) Appl. No.: 14/796,044

(22) Filed: Jul. 10, 2015

Related U.S. Application Data
(62) Division of application No. 13/498,417, filed on Mar. 27, 2012.
(60) Provisional application No. 61/246,687, filed on Sep. 29, 2009.

(51) Int. Cl. B23P 15/26

(52) U.S. Cl. CPC B23P 15/26

(57) ABSTRACT

A conduit is processed for installation in a heat exchange system as an expansion. In particular, the conduit is crushed to modify one or more flow parameters of the invention. The crushing of the conduit is preformed according to one or more crush parameters determined to ensure that refrigerant flowing through the conduit within the heat exchange system will experience a pressure drop of a predetermined amount while travelling through the conduit.

### CROSS-REFERENCE TO RELATED APPLICATIONS

This application is a Divisional under 35 U.S.C. §120 of U.S. patent application Ser. No. 13/498,417, filed Mar. 27, 2012, which claims the priority benefit under 35 U.S.C. §371 of international patent application no. PCT/IB2010/053720, filed Aug. 17, 2010, which claims the priority benefit under 35 U.S.C. §119(e) of U.S. Provisional Application No. 61/246,687 filed on Sep. 29, 2009, the contents of which are herein incorporated by reference.

### BACKGROUND OF THE INVENTION

1. Field of the Invention

The invention relates to heat exchange systems, and specifically to the processing of conduits for inclusion within heat exchange systems as expansions.

2. Description of the Related Art

Heat exchange systems implementing open ended capillary tubes as expansions are known. However, conventional techniques for accommodating imprecise manufacturing tolerances of such tubes tend to require extensive operator intervention at the individual tube level. Consequently, such techniques tend to be costly and inconsistent.

### SUMMARY OF THE INVENTION

One aspect of the invention relates to a heat exchange system. In one embodiment the system comprises an expansion and a compressor. The expansion is configured to form a portion of a flow path for refrigerant within the system, and comprises a conduit. The compressor is configured to apply a force to refrigerant that forces the refrigerant through the flow path such that a pressure drop is experienced by the refrigerant as the expansion cools the refrigerant. The conduit has been mechanically crushed to adjust one or more flow parameters of the portion of the flow path provided by the expansion.

Another aspect of the invention relates to a method of processing a conduit prior to installation in a heat exchange system, the conduit being configured by the processing to expand refrigerant flowing through the conduit such that refrigerant flowing through the conduit experiences a pressure drop of a predetermined amount while traveling through the conduit. In one embodiment, the method comprises: performing a crushing operation on a conduit, wherein the crushing operation adjusts one or more flow parameters of the conduit; measuring one or more flow parameters of the conduit that have been adjusted by the crushing operation; determining whether the crushing operation should be stopped based on the measured one or more flow parameters of the conduit; stopping the crushing operation responsive to a determination that the crushing operation should be stopped.

Yet another aspect of the invention relates to a system configured to provide a heat exchanger. In one embodiment, the system comprises: means for forming a flow path for refrigerant, wherein the flow path comprises one or more expansions that provide pressure drops to refrigerant traveling through the flow path; and means for applying a force to refrigerant that forces the refrigerant through the flow path such that pressure drops experienced by the refrigerant at the expansions of the flow path cools the refrigerant; wherein the means for forming the flow path has been mechanically crushed in at least one section of the flow path to adjust one or more flow parameters of the flow path provided by the means for forming the flow path.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. In one embodiment of the invention, the structural components illustrated herein are drawn to scale. It is to be expressly understood, however, that the drawings are for the purpose of illustration and description only and are not a limitation of the invention. In addition, it should be appreciated that structural features shown or described in any one embodiment herein can be used in other embodiments as well. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a heat exchange system, in accordance with one or more embodiments of the invention;

FIG. 2 illustrates conduits having varying flow parameters, according to one or more embodiments of the invention;

FIG. 3 illustrates a method of processing a conduit to configure the conduit for installation in an expansion of a heath exchange system, in accordance with one or more embodiments of the invention;

FIG. 4 illustrates a plot implemented to flow test sample conduit, according to one or more embodiments of the invention; and

FIG. 5 illustrates a method of processing a conduit to configure the conduit for installation in an expansion of a heat exchange system, in accordance with one or more embodiments of the invention.

### DETAILED DESCRIPTION OF EXEMPLARY EMBODIMENTS

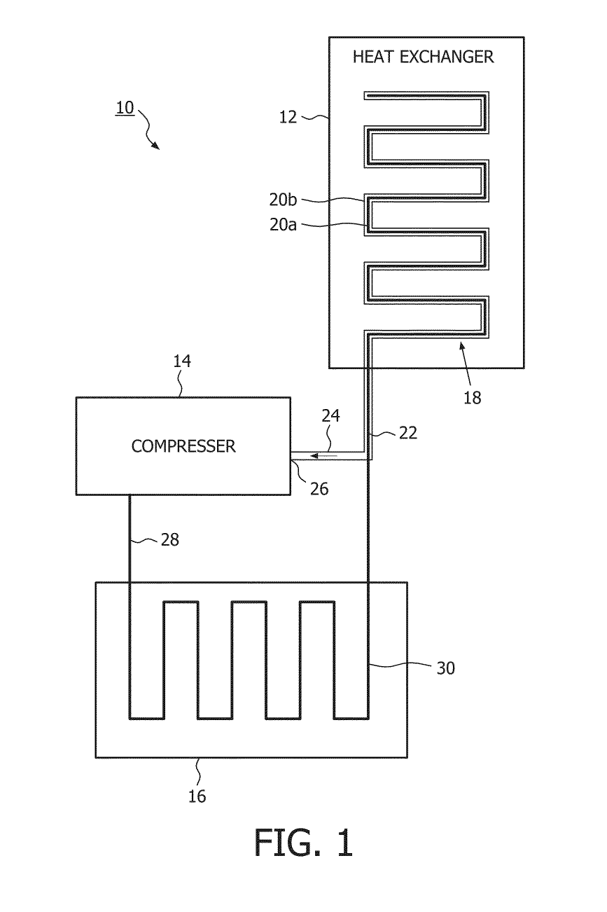

FIG. 1 illustrates a heat exchange system 10 configured to provide a heat exchanger 12 to cool a body, fluid, volume, and/or other entity. The heat exchange system 10 relies on compression refrigeration to generate heat exchanger 12. As such, heat exchange system 10 provides a flow path for refrigerant that cools the refrigerant prior to circulating the refrigerant through heat exchanger 12. One or more of the components of heat exchange system 10 are formed with precision to ensure that heat exchanger 12 is generated to accept a relatively large amount of heat, operate with an enhanced efficiency, and/or otherwise operate in an enhanced manner. In one embodiment, heat exchange system 10 is a component of a system configured to liquefy fluid that is in a gaseous state at ambient temperature and pressure. However, this is not intended to be limiting, and heat exchange system 10 may be implemented in a variety of settings without departing from the scope of this disclosure. In one embodiment, heat exchange system 10 includes one or more of heat exchanger 12, a compressor 14, a condenser 16, an expansion 18, and/or other components.

Heat exchanger 12 is a section of the flow path through which super-cooled refrigerant circulates. In one embodiment, the temperature of the refrigerant circulating through heat exchanger 12 is below about −100° K. In one embodiment, heat exchanger 12 includes a heat exchanger conduit 20 that circulates the refrigerant through heat exchanger 12 from a heat exchanger inlet 22 to a heat exchanger outlet 24. Heat exchanger conduit 20 may be coiled and/or serpentine. This will tend to enhance the amount of heat that can be absorbed by heat exchanger 12 per unit of volume. Heat exchanger conduit 20 may be formed from a thermally conductive material, thereby enabling heat to be absorbed by the refrigerant after passing through the wall of the heat exchanger conduit 20. By way of non-limiting example, heat exchanger conduit 20 may be formed from a metallic material such as copper, aluminum, stainless steel, other metallic materials, and/or other thermally conductive non-metallic materials. In one embodiment, the heat exchanger conduit 20 is formed from a solid, rigid material. In one embodiment, heat exchanger conduit 20 is formed to be less rigid. For instance, heat exchanger conduit 20 may be formed as a braided conduit to provide some level of pliability.

In one embodiment illustrated in FIG. 1, heat exchanger 12 is a counter-flow heat exchanger. In this embodiment, heat exchange conduit 20 includes an in-flow capillary conduit 20a and an out-flow conduit 20b that surrounds in-flow capillary conduit 20a. In the counter-flow heat exchanger 12, refrigerant is pushed through the in-flow capillary conduit 20a, and then circulates back out of heat exchanger 12 through the out-flow conduit 20b along the outside of inflow-capillary conduit 20a, thereby providing additional cooling to the refrigerant within in-flow capillary conduit 20a.

After refrigerant has circulated through heat exchanger conduit 20, the refrigerant is provided into compressor 14 through heat exchanger outlet 24. The compressor is configured to pressurize the refrigerant. Compressor 14 receives the refrigerant from heat exchanger conduit 20 at a refrigerant inlet 26, and emits the pressurized refrigerant out of a compressor outlet 28. In one embodiment, compressor 14 emits the refrigerant at a pressure of about 350 psi. By increase in the pressure of the refrigerant within compressor 14, the temperature of the refrigerant emitted by compressor 14 is typically much greater than the refrigerant received into compressor 14 from heat exchanger 12. For example, the temperature of the refrigerant may be about 70° C.

In the flow path formed by heat exchange system 10, the pressurized refrigerant emitted by compressor 14 is received into condenser 16. Condenser 16 is configured to cool the pressurized refrigerant. However, condenser 16 does not cool the refrigerant to the levels of the refrigerant within heat exchanger 12. Instead, in one embodiment, the pressurized refrigerant within condenser 16 is cooled to roughly ambient temperature. For example, condenser 16 may be formed from a condenser conduit 30 that is made from a thermally conductive material. By exposing condenser conduit 30 to ambient atmosphere, the ambient atmosphere provides a heat exchanger for condenser 16 that enables the refrigerant within condenser 16 to be cooled to roughly the temperature of ambient atmosphere.

In one embodiment, condenser conduit 30 may be formed from a metallic material such as copper, aluminum, stainless steel, other metallic materials, and/or other thermally conductive non-metallic materials. In one embodiment, the condenser conduit 30 is formed from a solid, rigid material. In one embodiment, condenser conduit 30 is formed to be less rigid. For instance, condenser conduit 30 may be formed as a braided conduit to provide some level of pliability. To enhance the length of condenser conduit 30 per unit volume of condenser 16, condenser conduit 30 may be configured into a serpentine (e.g., coiled, etc.) path.

Expansion 18 is configured to expand the refrigerant after the refrigerant has been somewhat cooled within condenser 16. As will be appreciated, expansion of the refrigerant results in the refrigerant being super-cooled to the level of the refrigerant within heat exchanger 12. In one embodiment, expansion 18 is formed within heat exchanger 12 by the in-flow capillary conduit 20a. As the refrigerant flows through the in-flow capillary conduit 20a, the refrigerant is slowly expanded by a gradual reduction in pressure that continues up until the refrigerant is emptied into out-flow conduit 20b. By virtue of this expansion, and the cool refrigerant flowing within out-flow conduit 20b along the exterior of in-flow capillary conduit 20a, the refrigerant inside of in-flow capillary conduit 20a becomes super-cooled. It will be appreciated that the illustration in FIG. 1, and the description herein, of expansion 18 (and heat exchanger 12) including a single in-flow capillary conduit is for illustrative purposes only. In one embodiment, expansion 18 (and heat exchanger 12) includes a plurality of in-flow capillary conduits configured similarly to in-flow capillary conduit 20a.

In one embodiment, for expansion 18 to function properly (e.g., by providing the appropriate pressure drop while traveling through expansion 18), the physical dimensions of in-flow capillary conduit 20a must be more precise than can be readily obtained through conventional mass-production techniques. For example, the length and/or flow area, and/or related dimensions (e.g., inner diameter, etc.) may not be readily available at production tolerances that will reliably ensure proper operation of expansion 18 and heat exchanger 12. As such, at manufacture of heat exchange system 10, in-flow capillary conduit 20a must be further processed to ensure proper operation of expansion 18 and heat exchanger 12.

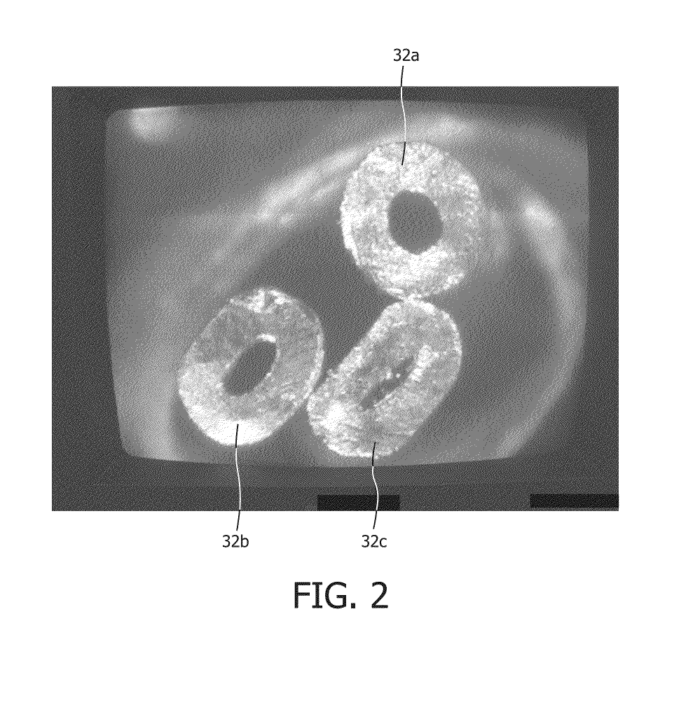

In one embodiment, in-flow capillary conduit 20a is crushed to provide in-flow capillary conduit 20a with the precise and appropriate flow parameters that will enable heat exchange system 10 to function properly. In particular, as should be appreciated, crushing expansion conduit 32 will effectively reduce the flow area within in-flow capillary conduit 20a at the location(s) that are crushed. As used herein, “location(s)” on in-flow capillary conduit 20a does not necessarily refer to individual positions along a length of conduit that are crushed. Instead, the “location(s)” along a length of conduit that are crushed refers to one or more lengths of the conduit that are crushed in a continuous, or substantially continuous, manner. By way of illustration, FIG. 2 illustrates a plurality of conduits 32 (illustrated in FIG. 2 as first conduit 32a, second conduit 32b, and third conduit 32c) with preliminary flow parameters that were substantially the same, but that have been provided with varying flow area by crushing operations. Specifically, first conduit 32a has not been crushed, and maintains its preliminary flow area. By contrast, second conduit 32b has been crushed somewhat, thereby reducing the cross-sectional flow area of second conduit 32b with respect to the preliminary flow area. Third conduit 32c has been crushed more than the second conduit 32b, thereby reducing the cross-sectional flow area even further than was accomplished for second conduit 32b.

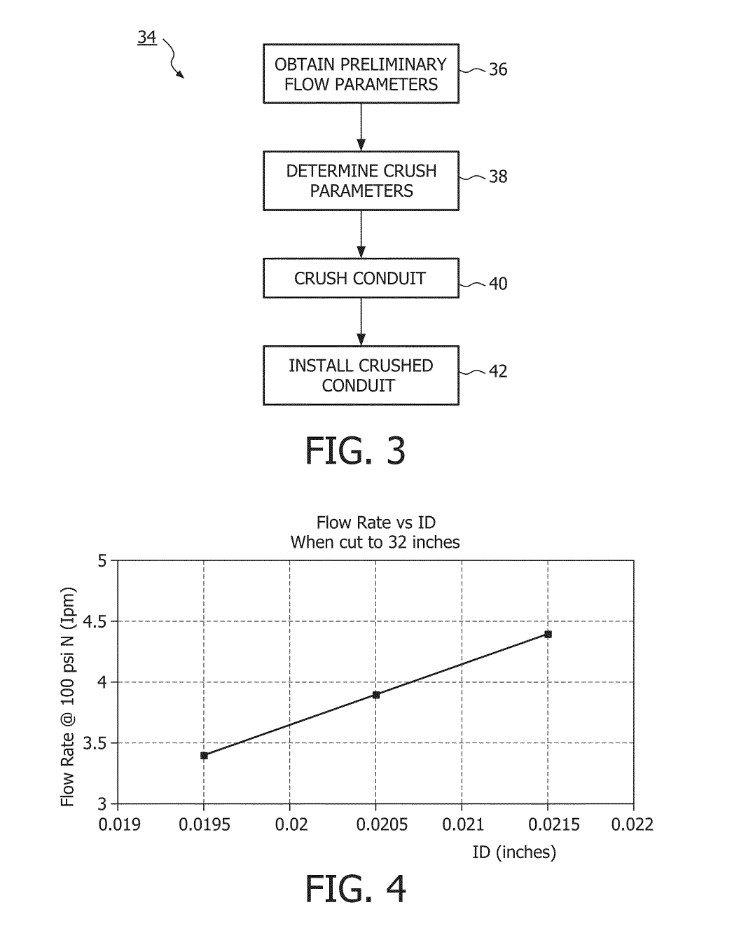

FIG. 3 illustrates a flow chart of a method 34 of processing a conduit prior to installation in a heat exchange system (e.g., heat exchange system 10 shown in FIG. 1 and described above). The conduit is configured by the processing of method 34 to expand refrigerant flowing through the conduit in a predetermined manner. In one embodiment, refrigerant flowing through the conduit experiences a pressure drop of a predetermined amount while traveling through the conduit.

It will be appreciated that the operations shown in FIG. 3 and described below are not intended to be limiting. In one embodiment one or more of the operations may be omitted, two or more of the operations may be combined, and/or one or more operations may be added to the method 34 without departing from the scope of this disclosure. Further, the order of the operations illustrated in FIG. 3 and described below are illustrative, and method 34 can be accomplished without performing all of the operations in the precise order set forth.

In one embodiment, one or more of the operations of method 34 may be performed by one or more processors configured to execute computer program modules effecting performance of the operations. Such performance may be automated and/or may require user input and/or control. However, method 34 may be practiced outside of this context without departing from the scope of this disclosure.

At an operation 36, one or more preliminary flow parameters of a conduit are obtained. The one or more preliminary flow parameters comprise parameters of the conduit related to the flow path for fluids provided by the conduit. By way of non-limiting example, the one or more preliminary flow parameters of the conduit may include one or more physical measurements of the conduit (e.g., a length, an inner diameter, a flow area, etc.), a flow rate of a fluid through the conduit, a pressure of a flow of fluid through the conduit, and/or other parameters. In one embodiment, the one or more preliminary flow parameters of the conduit include a flow area of the conduit at one or more locations along the conduit, and a length of the conduit.

Obtaining the one or more preliminary flow parameters at operation 36 may include one or more of directly measuring a preliminary flow parameter of the conduit, calculating or estimating a preliminary flow parameter of the conduit, obtaining a previously determined flow parameter, and/or otherwise obtaining preliminary flow parameters. By way of non-limiting example, length of the conduit may be easily ascertainable by direct measurement. As such, in one embodiment, operation 36 includes measuring the length of the conduit directly. As another non-limiting example, cross-sectional dimensions of the conduit (e.g., inner diameter, flow area, etc.) may not be readily ascertainable in a production environment. As such, at operation 36, a flow parameter related to cross-section dimensions of the conduit may be obtained based on a previous measurement, calculation, and/or estimate of this flow parameter made for conduits within the same batch as the conduit.

In one embodiment, operation 36 includes obtaining a flow parameter of the conduit that has been previously measured, calculated, and/or estimated for the batch of conduits of which the conduit is a part. As used herein, the term “batch” refers to a group of conduits produced by a conduit manufacturer together. Typically, such a group will have been formed from the same stock material and on the same set of machines calibrated in the same or similar manners. As such, variations in dimensions of the conduits in the same “batch” will be relatively small compared within variations in the same dimensions of conduits in different “batches.” In one embodiment, a “batch” of conduit includes a single length of conduit that can be cut for use as individual conduits within a heat exchange system.

In one embodiment, to determine the flow parameter related to the inner dimensions of the conduits from the same batch as the conduit being processed by method 34, a sample of the conduits from the batch are flow tested to estimate the flow parameter related to the inner dimensions of the conduits. By way of illustration, FIG. 4 shows a plot of estimated inner diameter versus flow rate for a flow of 100 psig nitrogen through a sample conduit 32 inches in length. From this plot, the inner diameter of a batch of conduits (e.g., including the conduit being processed according to method 34 illustrated in FIG. 3) may be estimated based on the flow rate of a flow of 100 psig nitrogen through a sample conduit from the batch that is 32 inches in length. This estimate may then be implemented in the processing of all of the conduits within the batch.

Returning to FIG. 3, in one embodiment, operation 36 includes obtaining a flow parameter related to the outer diameter of the conduit that has been previously stored for the batch of conduits including the conduit being processed. Because outer diameter is a flow parameter likely to vary relatively little between conduits within a common batch, this previously stored parameter may have been originally determined by directly measuring a sample of conduit from the batch of conduits.

At an operation 38, one or more crush parameters of a crushing operation to be performed to the conduit are determined. The one or more crush parameters are determined based on the one or more preliminary flow parameters obtained at operation 36. The one or more crush parameters define a crushing operation that will adjust one or more of the flow parameters of the conduit such that if the conduit is installed within an expansion in a heat exchange system, refrigerant flowing through the conduit will experience a pressure drop of a predetermined amount at the expansion. As such, the determination of the crush parameters at operation 38 may be made based on the predetermined amount of the pressure drop, as well as the one or more preliminary flow parameters. In one embodiment, the one or more crush parameters include one or more of crush height, location on the conduit (to be crushed at a given crush height), and/or other parameters of a crush operation.

In one embodiment, the one or more crush parameters are determined at operation 38 by a look-up table that provides crush parameter(s) as a function of preliminary flow parameter(s). However, this is not intended to be limiting, and other approaches for determining crush parameter(s) as a function preliminary flow parameter(s) and/or predetermined amount of pressure drop may be implemented.

At an operation 40, the conduit is crushed in accordance with the one or more crush parameters determined at operation 38. In one embodiment, the conduit is crushed using crush rollers. The crush rollers may be of different and/or adjustable sizes, and/or a fixture implemented in operation 40 may enable a controllable crush height to perform crushing in accordance with the specific crush parameters determined at operation 38.

At an operation 42, the conduit is installed in an expansion of a heat exchange system. In one embodiment, the heat exchange system is the same as or similar to heat exchange system 10 (shown in FIG. 1 and described above).

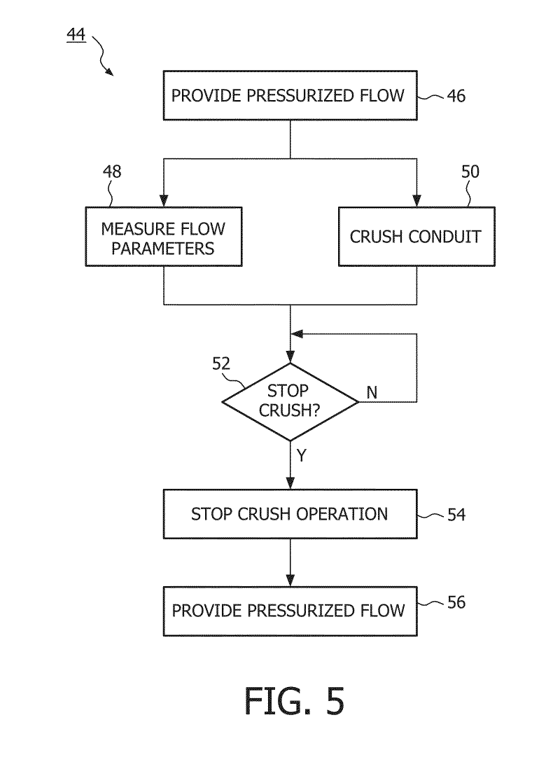

FIG. 5 illustrates a flow chart of a method 44 of processing a conduit prior to installation in a heat exchange system (e.g., heat exchange system 10 shown in FIG. 1 and described above). The conduit is configured by the processing of method 44 to expand refrigerant flowing through the conduit in a predetermined manner. In one embodiment, refrigerant flowing through the conduit experiences a pressure drop of a predetermined amount while traveling through the conduit.

It will be appreciated that the operations shown in FIG. 5 and described below are not intended to be limiting. In one embodiment one or more of the operations may be omitted, two or more of the operations may be combined, and/or one or more operations may be added to the method 44 without departing from the scope of this disclosure. Further, the order of the operations illustrated in FIG. 5 and described below are illustrative, and method 44 can be accomplished without performing all of the operations in the precise order set forth.

In one embodiment, one or more of the operations of method 44 may be performed by one or more processors configured to execute computer program modules effecting performance of the operations. Such performance may be automated and/or may require user input and/or control. However, method 44 may be practiced outside of this context without departing from the scope of this disclosure.

At an operation 46, a pressurized flow of fluid is provided to a first opening of a conduit. At an operation 48, one or more flow parameters of a conduit are measured. The one or more flow parameters are measured by measuring one or more gas parameters of the flow of fluid flowing through the conduit. The one or more flow parameters measured in this manner may include one or more of a flow rate of the pressurized flow of fluid through the conduit, a volume of the pressurized flow of fluid through the conduit, a pressure of the pressurized flow of fluid through the conduit, and/or other flow parameters.

At an operation 50, while the measurement of operation 48 is being sampled in an ongoing manner, a crushing operation is performed on the conduit. The crushing operation crushes the conduit, thereby adjusting the flow parameters of the conduit. In one embodiment, the crushing operation is performed by crushing the conduit with one or more crush rollers while the measurements of operation 48 are sampled in an ongoing manner.

At an operation 52, the one or more flow parameters of the conduit measured at operation 48 are compared with predetermined levels corresponding to the one or more flow parameters. If it is determined at operation 52, that the one or more flow parameters of the conduit have reached the corresponding predetermined level(s), then the crushing operation of operation 50 is ended at an operation 54. This may include ceasing the crush rollers performing the crushing operation, and/or removing the conduit from the crush rollers. Otherwise, method 44 loops back over operation 52.

At an operation 56, the crushed conduit is installed in an expansion of a heat exchange system. In one embodiment, the heat exchange system is the same as or similar to heat exchange system 10 (shown in FIG. 1 and described above).

It will be appreciated that the description the ongoing sampling of the one or more flow parameters during the performance of the crushing operation is not intended to be limiting. In one embodiment, the crush operation may be performed incrementally, with measurements of the one or more flow parameters being taken between increments of the crushing operation.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A method of processing a conduit prior to installation in a heat exchange system, the conduit being configured by the processing to expand refrigerant flowing through the conduit such that refrigerant flowing through the conduit experiences a pressure drop of a predetermined amount while traveling through the conduit, wherein the method comprises:
performing a crushing operation on a conduit with crush rollers, wherein the crushing operation adjusts one or more flow parameters of the conduit, and wherein the conduit is formed from a braided, thermally conductive material;
measuring one or more flow parameters of the conduit that have been adjusted by the crushing operation;
determining whether the crushing operation should be stopped based on the measured one or more flow parameters of the conduit;
stopping the crushing operation responsive to a determination that the crushing operation should be stopped.

2. The method of claim 1, further comprising providing a pressurized flow of fluid to a first opening of the conduit, and wherein measuring the one or more flow parameters of the conduit comprises measuring one or more parameters of the pressurized flow of fluid through the conduit.

3. The method of claim 2, wherein the one or more parameters of the pressurized flow of fluid through the conduit comprise a flow rate of the flow of fluid, a pressure of the flow of fluid, or a volume of the flow of fluid.

4. The method of claim 1, wherein the crushing operation effectively reduces the flow area within the conduit.

5. The method of claim 1, further comprising installing the conduit within the heat exchange system.
